(19) United States
(12) Patent Application Publication
(10) Pub. No.: US 2026/0340728 A1
(43) Pub. Date: Oct. 29, 2026

(54) SECURE AND AUTOMATED DATA MANAGEMENT SYSTEM FOR ACCOUNTS ON HETEROGENEOUS PLATFORMS

(71) Applicant: Truist Bank, Charlotte, NC (US)

(72) Inventor: Prasad P. Jahagirdar, Charlotte, NC (US)

(73) Assignee: Truist Bank, Charlotte, NC (US)

(21) Appl. No.: 19/188,976

(22) Filed: Apr. 24, 2025

(51) Int. Cl. G06Q 40/06; G06F 9/451; H04L 9/40

(52) U.S. Cl. CPC G06Q 40/06; H04L 63/083; G06F 9/451

(57) ABSTRACT

In one embodiment, a computer-implemented method includes an enterprise server acquiring, from a client device, client data to link a second account to a first account managed by the enterprise server. The client data includes a consent for access rights and second authentication credentials for accessing the second account. Also, the enterprise server stores the client data and transmits, to a third-party server device, a request to access the second account using the second authentication credentials. The enterprise server receives an access token to gain access to the second account and acquires second account data relating to the second account from the third-party server device. In addition, the enterprise server generates a first GUI for display on the client device, with the first GUI aggregating together multiple account data. Moreover, the enterprise server receives a user request to execute a transaction and executes the transaction using the access token.

### TECHNICAL FIELD

The present invention relates to data management systems, and more specifically, the present invention relates to a single data management system for managing accounts on heterogeneous platforms.

### BACKGROUND

In the field of data management and financial transactions, there is a need to efficiently and securely link together accounts across different platforms for the purpose of accessing and aggregating data, as well as executing inter-account transfers and payments from a single portal. This issue is particularly acute for users who wish to manage multiple accounts through a single platform and for businesses that need to integrate non-enterprise accounts into their enterprise systems. Existing solutions fall short in providing a secure method for obtaining user consent and credentials, leading to inefficiencies and potential security risks, nor do they allow for financial transactions across different platforms.

Conventional technologies generally focus on managing data through various means, such as using non-relational and relational databases, enhanced recommendation systems, and estimating attribute values based on historical transaction data. These technologies address specific aspects of data management, such as improving recommendation accuracy, predicting future values of attributes, and controlling access to protected data resources. However, they do not adequately address the need to link together accounts across different platforms.

### SUMMARY

In one embodiment, a computer-implemented method for managing multiple accounts is described. The computer-implemented method includes an enterprise server acquiring, from a client device, client data to link a second account to a first account managed by the enterprise server, where the client device is authenticated to conduct transactions relating to the first account, and where the client data includes: a) a consent for access rights to the second account managed by a third-party server device, and b) second authentication credentials for accessing the second account. The computer-implemented method also includes the enterprise server storing the client data to a first storage location accessible to the enterprise server and transmitting, to the third-party server device, a request to access the second account using the second authentication credentials. The computer-implemented method further includes the enterprise server receiving an access token from the third-party server device to gain access to the second account and acquiring second account data relating to the second account from the third-party server device. In addition, the method includes the enterprise server generating a first graphical user interface (GUI) for display on the client device, with the first GUI aggregating together the second account data and first account data relating to the first account managed by the enterprise server. Moreover, the method includes the enterprise server receiving, via the first GUI, a user request to execute a first transaction involving the second account and executing the first transaction using the access token to access the second account on the third-party server device.

In another embodiment, a system for managing multiple accounts is described. The system includes at least one processor and a non-transitory computer-readable medium having instructions embodied therewith that, when executed by the at least one processor, cause the at least one processor to perform operations. The operations include an enterprise server acquiring, from a client device, client data to link a second account to a first account managed by the enterprise server, where the client device is authenticated to conduct transactions relating to the first account, and where the client data includes: a) a consent for access rights to the second account managed by a third-party server device, and b) second authentication credentials for accessing the second account. The operations also include the enterprise server storing the client data to a first storage location accessible to the enterprise server and transmitting, to the third-party server device, a request to access the second account using the second authentication credentials. The operations further include the enterprise server receiving an access token from the third-party server device to gain access to the second account and acquiring second account data relating to the second account from the third-party server device. In addition, the operations include the enterprise server generating a first GUI for display on the client device, with the first GUI aggregating together the second account data and first account data relating to the first account managed by the enterprise server. Moreover, the operations include the enterprise server receiving, via the first GUI, a user request to execute a first transaction involving the second account and executing the first transaction using the access token to access the second account on the third-party server device.

According to another embodiment, a computer program product for managing multiple accounts is described. The computer program product includes a non-transitory computer-readable storage medium having program instructions embodied therewith that, when executed by the at least one processor, cause the at least one processor to perform operations. The operations include an enterprise server acquiring, from a client device, client data to link a second account to a first account managed by the enterprise server, where the client device is authenticated to conduct transactions relating to the first account, and where the client data includes: a) a consent for access rights to the second account managed by a third-party server device, and b) second authentication credentials for accessing the second account. The operations also include the enterprise server storing the client data to a first storage location accessible to the enterprise server and transmitting, to the third-party server device, a request to access the second account using the second authentication credentials. The operations further include the enterprise server receiving an access token from the third-party server device to gain access to the second account and acquiring second account data relating to the second account from the third-party server device. In addition, the operations include the enterprise server generating a first GUI for display on the client device, with the first GUI aggregating together the second account data and first account data relating to the first account managed by the enterprise server. Moreover, the operations include the enterprise server receiving, via the first GUI, a user request to execute a first transaction involving the second account and executing the first transaction using the access token to access the second account on the third-party server device.

### DRAWINGS

The various advantages of the exemplary embodiments will become apparent to one skilled in the art by reading the following specification and appended claims, and by referencing the following drawings.

FIG. 1 is a flow chart of a computer-implemented method for managing multiple accounts across platforms, according to one embodiment.

FIG. 2 is a flow chart of a computer-implemented method for acquiring account data for managing multiple accounts in a single platform, according to one embodiment.

FIG. 3 is a flow chart of a computer-implemented method for executing transactions for linked accounts, according to one embodiment.

FIG. 4 is a flow chart of a computer-implemented method for executing transactions for linked accounts, according to one embodiment.

FIG. 5 is a flow chart of a computer-implemented method for executing transactions for linked accounts, according to one embodiment.

FIG. 6 shows a simplified wealth management platform in accordance with one embodiment.

FIG. 7 shows a simplified file management platform in accordance with one embodiment.

FIG. 8 shows a block diagram of an example computing system that may implement the features and processes of any of FIGS. 1-7.

FIG. 9 illustrates an example network architecture that may implement the features and processes of any of FIGS. 1-7.

### DESCRIPTION

In the following descriptions, for the purposes of explanation, numerous specific details are set forth to provide a thorough understanding to the reader but are not meant to limit the claimed invention in any way. One or more embodiments may be practiced without these specific details. Features described in one embodiment may be used in combination with features described in a different embodiment in various possible combinations and permutations. In some examples, well-known structures and devices are described with reference to block diagrams to avoid unnecessarily obscuring the claimed invention.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### Definitions

Several non-limiting example definitions are provided below for clarity and illustrative purposes in reading these descriptions and should not be construed to limit the scope of the one or more embodiments disclosed herein in any manner. It is also contemplated that these and other terms may also be defined by their common uses in the context of these descriptions.

The term “about” as used herein indicates the value preceded by the term “about,” along with any values reasonably close to the value preceded by the term “about,” as would be understood by one of skill in the art. When not indicated otherwise, the term “about” denotes the value preceded by the term “about” ±10% of the value. For example, “about 10” indicates all values from and including 9.0 to 11.0.

As used herein, “application” may relate to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into individual applications which reside on a client device (e.g., virtual private network (VPN) client, Microsoft® PowerPoint®, Microsoft® Excel®, etc.) and cloud applications which may reside in the cloud (e.g., Google® Gmail®, GitHub®). Cloud applications may correspond to applications on the client device or may be multi-user applications, such as social media applications (e.g., Facebook®, Linkedin®, etc.).

As used herein, “artificial intelligence” or “AI” may relate to one or more computer systems operable to perform one or more tasks that normally require human intelligence and learning capabilities, such as visual perception, speech recognition, decision-making, and translation between languages.

As used herein, “dynamically” may relate to events or actions that can be caused, triggered, or otherwise occur without human intervention.

As used herein, “machine learning” may relate to an application of AI that provides computer systems the ability to automatically learn and improve from data and experience without being explicitly programmed.

As used herein, “computer” may relate to a single computer or to a system of interacting computers. A computer is a combination of a hardware system, a software operating system and perhaps one or more software application programs. Examples of a computer include, without limitation, a personal computer (PC), a desktop computer, a server, a mainframe, an appliance device, a laptop computer, a smartphone, a satellite phone, a tablet computer, etc.

As used herein, “client device” may relate to any system, apparatus, and/or device associated with a user (who may be a client, customer, administrator, or some other person accessing the device), including personal computers, laptops, tablets, and/or mobile smartphones.

As used herein, “modules” may relate to software modules (e.g., code embodied on a machine-readable medium or in a transmission signal), hardware modules, or a combination thereof. Certain embodiments are described herein as including logic or a number of components, modules, or mechanisms.

As used herein, a “software module” (or just “software”) may relate to code embodied on a computer-readable medium or in a transmission signal for performing or causing performance of one or more tasks by one or more processors. Software may relate to a set of instructions and associated documentation that direct one or more processors or a computer what to do or how to perform a task. Software may include any different types of software programs executable on a computer, such as applications and/or the operating system. A software application may be written in substantially any suitable programming language, which would be easily selectable by one of ordinary skill in the art. The programming language chosen should be compatible with the computer by which the software application is to be executed and, in particular, with the operating system of that computer. Examples of suitable programming languages include, without limitation, Object Pascal, C, C++, Common Gateway Interface (CGI), Java, Java Scripts, etc. Further, the functions of some embodiments, when described as a series of steps for a method, could be implemented as a series of software instructions for being operated by a processor, such that the embodiments could be implemented as software, hardware, or a combination thereof.

A “hardware module” (or just “hardware”) as used herein may relate to a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field Programmable Gate array (FPGA) or an application specific integrated circuit (ASIC).

A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module.

Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” may relate to any combination of electronic communication networks, including, without limitation, the Internet, a local area network (LAN), a wide area network (WAN), a wireless network, and a cellular network, e.g., General Packet Radio Service (GPRS), Long Term Evolution (LTE), 4G, 5G, etc.

As used herein, “processes” or “methods” are presented in terms of methods or symbolic representations of operations performed on data stored as bits or binary digital signals within a computer-readable memory (e.g., a machine memory). These methods or symbolic representations are examples of techniques used by those of ordinary skill in the art of data processing to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” may relate to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” may relate to a server computer or group of computers that acts to provide a service for a certain function or access to a network resource. In various examples, a server may be a physical server, a hosted server in a virtual environment, or software code running on a hardware platform.

As used herein, “service” or “application” may relate to software executable by one or more processors (e.g., an online server or set of servers) to perform one or more tasks and may refer to locally executed software (e.g., operating system, web browser, etc.) or software that is remotely accessible (e.g., a web site, web application, cloud application, etc.).

As used herein, “sensor” may relate to any device, component and/or system that is configured to perform one or more of detecting, determining, assessing, monitoring, measuring, quantifying, and sensing operations.

As used herein, “real-time” may relate to a level of processing responsiveness that a user, module, or system senses as sufficiently immediate for a particular process or determination to be made, or that enables the processor to keep up with an external process.

As used herein, “user” may relate to a consumer, customer, administrator, operator, machine entity, and/or requesting party, and may be human or machine in various approaches.

### Cross-Platform Data Management System

Systems that use machine learning (ML) models for recommendations or attribute estimation often rely on historical user data and transaction records to generate insights. While these systems may provide useful information, they do not solve the problem of securely linking accounts across different platforms. Similarly, systems that manage access to data based on permissions and user identities may help control and limit access to protected resources, but they do not provide a comprehensive solution for securely linking non-enterprise accounts to enterprise accounts across different platforms.

Moreover, conventional systems that generate data models to map relationships between data assets or manage access to data elements within data record objects focus on internal data management and do not address the challenge of securely linking accounts across different platforms. These systems typically require user consent and credentials but often lack a robust mechanism for obtaining and securely handling this information in a manner that is seamless for the user.

Described herein, according to multiple embodiments, are systems, methods, and computer program products that enable efficient and secure linking of accounts across different platforms, thereby providing users and businesses with the ability to manage multiple accounts through a single platform without compromising security.

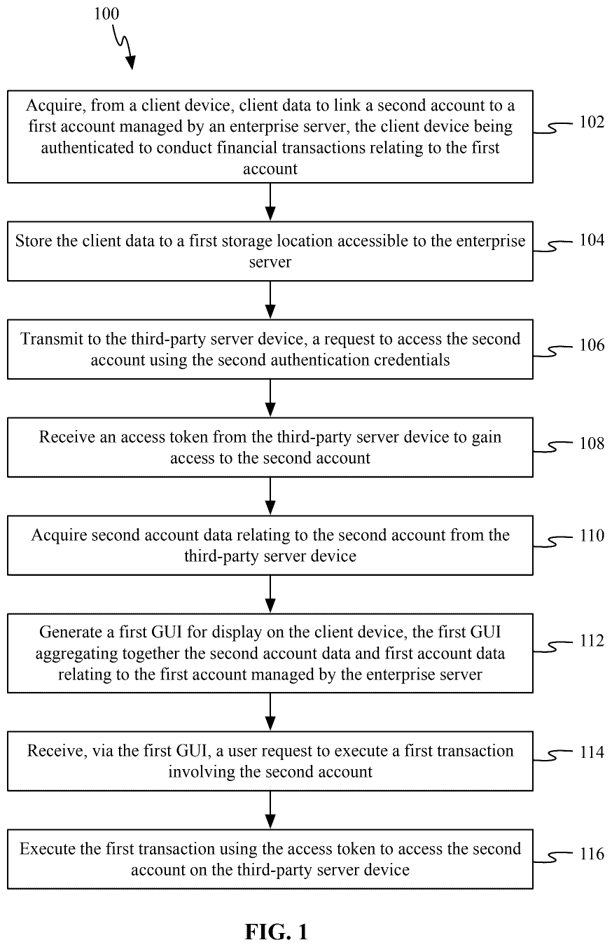

Referring now to FIG. 1, a flow chart of a computer-implemented method 100 for managing multiple accounts across platforms is shown according to one embodiment. Of course, more or less operations than those specifically described in FIG. 1 may be included in computer-implemented method 100, as would be understood by one of skill in the art upon reading the present descriptions.

Each of the operations of computer-implemented method 100 may be performed by any suitable component of the operating environment. For example, in various embodiments, computer-implemented method 100 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 100. Illustrative processors include, but are not limited to, a CPU, an ASIC, a FPGA, etc., combinations thereof, or any other suitable computing device known in the art.

In one embodiment, computer-implemented method 100 may be performed by an enterprise server that is configured to process electronic external and/or internal transactions and manage any number of accounts for one or more different platforms and/or electronic banking systems. Transactions may include any type of modification, exchange, movement, and/or trade, e.g., payments, deposits, transfers, copies, deletions, cancellations, etc. Although method 100 is described as being performed by an enterprise server, any suitable computing device may be used, alone or in combination with other electronic devices, to perform method 100 in various embodiments.

In operation 102, the enterprise server acquires client data from a client device. The client data that is acquired is designed to link a second account to a first account that is managed by the enterprise server. By “managed,” what is meant is that the enterprise server has access to the first account, and can at least perform external and/or internal transactions into, out of, or through the first account. Moreover, the enterprise server may view any and all transactions that affect the first account, and may retrieve and cause display of a history, statement, or record of such transactions on demand and/or through one or more graphical user interfaces (GUIs) provided to a client device for viewing and possibly downloading such transactions. The enterprise server is also configured to open, close, and modify accounts that are set up (e.g., through a platform) by a financial institute associated with such accounts (e.g., bank, brokerage, investment firm, etc.).

In some examples, the second account may be managed by another computing device or system (e.g., a third-party server device, different enterprise server, banking system, etc.) and may be accessible through a platform (e.g., online service, website, cloud service, etc.) specific to the second account that is different from the platform provided by the enterprise server.

The client device, prior to the enterprise server acquiring the client data, is authenticated to ensure that it is authorized to conduct transactions relating to the first account, in an example, such as financial transactions, e.g., setting up payment(s), setting up transfer(s), canceling payment(s), canceling transfer(s), viewing upcoming or future transaction(s), modifying a payment/transfer in a series of payments/transfers, etc. The authentication process may take any form, including those described herein in accordance with several embodiments, and others known in the art.

The client data may be received by the enterprise server in a message or transmission (pushed to the enterprise server) or pulled by the enterprise server from the client device, either directly or via one or more intermediary devices, routers, switches, etc. In some examples, the client device may be a mobile device of a user, a smartphone, tablet computer, desktop computer, smartwatch, etc., that is connected to a cellular network, Internet, and/or Wi-Fi network capable of exchanging data and information between the client device and the enterprise server.

In one embodiment, the client data may include a consent for access rights to the second account managed by the third-party server device. This consent allows the enterprise server to access the second account via the third-party server device. This client data may be stored by the enterprise server to be accessed later for verification and/or authorization when the enterprise server attempts to access the second account.

In an embodiment, the client data may include second authentication credentials for accessing the second account via the third-party server device. The second authentication credentials may include any of a password, a username, a unique code, information to administer two-factor authentication, a username and password combination for accessing the second account through an online portal managed by the third-party server device, an account number associated with the second account, a routing number associated with the second account, a unique account signature, etc.

In one approach, the enterprise server may verify whether the client device is registered for conducting transactions for at least one account. This determination will dictate whether computer-implemented method 100 should continue, in one approach, as a device that is not registered for conducting transactions on an account will not be allowed to proceed.

A registration process may be conducted when a user desires to have a client device authorized for conducting transactions for at least one account associated with the user. This registration process may proceed as described herein, or take some other form known in the art.

In one embodiment, prior to receiving the executing the transaction, the enterprise server may receive an electronic request to register the client device for conducting transactions for the first account managed by the enterprise server. This electronic request may be sent online via a website, through an application installed on the client device, via text message, or via some other electronic transmission technique. Preferably, the electronic request may be received via a secure electronic channel on which the user has already verified their identity, e.g., via login and password, two-factor authentication, fingerprint, face scan, etc. In response to this electronic request, the enterprise server may determine an identity of the client device (using a technique described herein or others known in the art). Once the identity of the client device is determined, the enterprise server may determine whether the client device is associated with an owner of the first account.

In an approach, this determination is based on the identity of the client device and the identity of the owner(s) of the first account. Typically, a mobile device's unique identifier will be associated with a particular user, and when this particular user is an owner of the first account managed by the enterprise server, the enterprise server will create a new user profile for this user and client device, or may modify an existing user profile associated with the first account to indicate registration of the client device for conducting transactions for the first account.

This registration between the client device and the first account in the user profile may be stored by the enterprise server to be accessed whenever a request is received to perform an action for this user, account(s), or client device.

In one embodiment, to verify if the client device is registered, the enterprise server may determine an identity of the client device. This identification may be used to determine whether the client device is registered for conducting transactions for at least one account managed by the enterprise server. Thereafter, the enterprise server will determine a device identifier associated with the client device, such as international mobile equipment identity (IMEI), international mobile subscriber identity (IMSI), media access control (MAC) address, etc. The enterprise server may then determine whether the device identifier is associated with a user profile accessible to the enterprise server. This user profile would also be associated with at least one account managed by the enterprise server.

In a further embodiment, the enterprise server may utilize a third-party service to determine an identity of the client device. This third-party service may reveal a unique identifier associated with the client device, such as IMEI, IMSI, MAC address, etc. Based on this unique identifier, the enterprise server is configured to determine whether the client device is listed as a registered device within a user profile associated with one or more accounts managed by the enterprise server.

In operation 104, the enterprise server stores the client data to a first storage location accessible to the enterprise server. The first storage location may be of any type of storage known in the art, such as random access memory (RAM), a programmable read-only memory (PROM), and erasable PROM (EPROM), a FLASH-EPROM, non-volatile random-access memory (NVRAM), any other memory chip or cartridge, content-addressable memory (CAM), ternary content-addressable memory (TCAM), hard disk drive (HDD), optical drive, etc.

In operation 106, the enterprise server transmits a request to access the second account using the second authentication credentials to the third-party server device. The request may take any form, such as an electronic note, a text message, an access token, etc. The request may include any relevant information needed to access the second account, such as authentication information, password/username combination, etc.

In operation 108, the enterprise server receives an access token from the third-party server device to gain access to the second account. The access token may take any form, such as a unique electronic identifier, a user name/password combination, a substring in a blockchain, etc.

In operation 110, the enterprise server acquires second account data relating to the second account from the third-party server device. The second account data may include information needed to access the second account within the platform hosted by the second server for displaying information regarding the second account, acquiring information related to the second account (e.g., account balances, recent transactions, related accounts, payees and payors, storage locations, authorized users, related accounts, etc.).

In various embodiments, the second account data may include any information that is relevant to understanding what the account is used for, what the user is able to interact with through the account, and ways in which the enterprise server is able to access the account through the third-party server device. In one embodiment in which the second account is a financial account, the second account data may include an amount of funds available in the second account, previous financial transactions related to the second account over a predetermined amount of time (e.g., 30 days, 60 days, 1 year, 5 years, since account inception), and one or more types of transactions that are available for execution with the second account and related execution criteria or parameters (to allow the enterprise server to learn which actions are available, and how to execute these transactions in the future).

In operation 112, the enterprise server generates a first GUI for display on the client device. In one example, the first GUI aggregates together the second account data and first account data relating to the first account managed by the enterprise server. However, the first GUI may take any shape or form needed to display information about the various accounts that are owned and/or accessible by the user of the client device, and have been linked with the enterprise server.

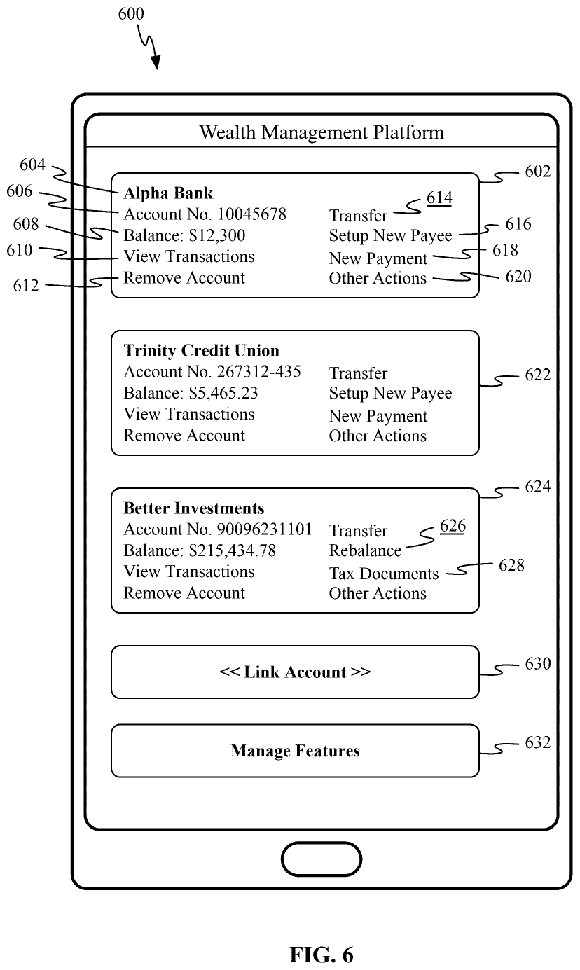

According to several examples, the first GUI may display information that is usable by the user of the client device to access the various accounts associated with the user, and execute transactions in relation to those accounts. These transactions may be financial and/or organizational in nature, in various examples. The GUI may show data and information about the various accounts, along with actions and option for interacting with the accounts in several examples. In operation 112, the first GUI may be configured similar to the GUI 600 as shown in FIG. 6, according to one embodiment,

Referring again to FIG. 1, in optional operation 114, the enterprise server receives, via the first GUI, a user request to execute a first transaction involving the second account, in an embodiment. The enterprise server may pull information and data entered into the first GUI from the client device to receive this request, or the client device may push the information and data to the enterprise server. The request may include details as to what type of transaction is to be performed, account(s) involved, platform(s) and/or systems on which the account(s) may be accessed, etc.

In various embodiments, the user request may adhere to a preset syntax for processing by the enterprise server. Some non-limiting example syntaxes are described below. However, any suitable and recognizable syntax may be used for describing the requested transaction and desired action to be performed.

In several embodiments, the user request may take the following syntax: “TYPE CODE DATE,” “CODE TYPE DATE,” DATE CODE TYPE,” or some other combination of these three parameters (or additional parameters described below). In these embodiments, “TYPE” describes the type of transaction(s) that will be viewed, modified, initiated, or cancelled; “CODE” describes the action to be performed for the transaction(s); and “DATE” indicates the date or starting date associated with the transaction(s).

For example, the “TYPE” parameter may indicate transactions having any of the following types, or others known in the art: automated clearing house (ACH), wire transfer, Zelle®, real time payment (RTP), Society for Worldwide Interbank Financial Telecommunication (SWIFT), electronic funds transfer (EFT), etc. Other types of transactions may be indicated by the “TYPE” parameter, such as copy, paste, move, delete, create new file, search, filter, etc.

In an example, the “CODE” parameter may indicate one of many different actions that may be performed for the related transaction(s), such as set up a new transfer or payment, cancel an existing transfer or payment, retrieve or view one or more (e.g., 1, 3, 5, 10, etc.) of the next scheduled transfers or payments, change an amount of a scheduled transfer or payment, change a recipient of a scheduled transfer or payment, change a date for performing a scheduled transfer or payment, etc.

In one example, the “DATE” parameter may indicate a date associated with performance of one or more transactions, or a starting date to view or retrieve scheduled transactions. The “DATE” parameter may be entered as numerical digits, e.g., “DDMMYYYY,” “MMDDYYYY,” “YYYYMMDD,” “DDMMYY,” or as a combination of digits and alphabetic characters, e.g., “DDMMMYY,” or in accordance with some other date convention that would be known to one of skill in the art. For example, Mar. 18, 2025 may be entered as “18032025,” 03182025,” “20250318,” “180325,” “18MAR25,” etc.

In several examples, the first transaction may be any of: a) an inter-account transfer or payment from the first account to the second account, b) an inter-account transfer or payment from the second account to the first account, c) a transfer or payment from the second account to a third account unrelated to the first account or the second account, etc.

In one example, the first transaction may involve a payee account or a payor account previously set up through the third-party server device. In this example, the first transaction may be executed using account information related to the payee or payor account acquired from the third-party server device.

In optional operation 116, the enterprise server executes the first transaction using the access token to access the second account on the third-party server device. This access is afforded based on the access token that was previously acquired by the enterprise server.

Execution of the first transaction may include setting up a future payment or transfer, canceling an existing payment or transfer, viewing scheduled payments or transfers, a modification to an existing transfer/payment, exchange of information or data, movement of data, file, or folder, trade, deposit, copying, deleting, cancellation, etc.

In one embodiment, the enterprise server may utilize a ML algorithm and/or artificial intelligence (AI) algorithm to make certain determinations when performing method 100. This ML and/or AI algorithm may learn, update, and adjust to determine which information is needed as client data in order to properly display information to the user via the first GUI. Moreover, the ML and/or AI algorithm may make better suggestions as to which accounts may be linked to the accounts managed by the enterprise server. In a further embodiment, the ML and/or AI algorithm may learn how to identify which data should be retrieved as second account data when linking the second account to the first account managed by the enterprise server.

The ML and/or AI algorithm may be trained based on multiple training data sets. One training data set may include all the required information and data needed to link an account with the enterprise server, another training data set may include proper access token information and usage for the enterprise server and other known platforms. In further examples, a training data set may include account data needed to populate a GUI for newly linked accounts and allow the user to view all details about the accounts from other platforms, while another training data set may include formats and protocols for accessing various different platforms outside of the enterprise server so that the system is able to adapt to other systems'requirements and properly request access therefrom.

By training the ML and/or AI algorithm on these various different aspects of linking and utilizing accounts from other platforms, the ML and/or AI algorithm will be able to help a user obtain and enter the needed information in the first GUI. Further, the ML and/or AI algorithm may be able to suggest or recommend other accounts that the user owns that could be viewed through the enterprise server's GUI.

In one embodiment, the enterprise server may cause display of a confirmation message to a GUI of the client device subsequent to execution of the transaction. This confirmation message may include information relevant to a user of the client device, such as confirmation that the requested transaction has or will be performed at some future date/time. In an approach, the confirmation message may include a timestamp associated with execution of the transaction in association with the relevant account, along with any relevant details about the account after execution of the transaction.

Referring again to FIG. 1, method 100 may be implemented in a system and/or a computer program product. For example, a system may include a processing circuit and logic integrated with the processing circuit, executable by the processing circuit, or integrated with and executable by the processing circuit. By integrated with, what is meant is that the processing circuit is a hardware processor that has hardcoded logic included therewith, such as an ASIC, a FPGA, etc. By executable by, what is meant is that the processing circuit is configured to execute software logic to achieve functionality dictated by the software logic. In this example, the logic is configured to cause the processing circuit to perform method 100.

In another example, a computer program product may include a computer-readable storage medium having program instructions embodied therewith. The computer-readable storage medium may be any suitable storage device known in the art that is configured to store and allow processor(s) access to information and data stored therein. In this example, the embodied program instructions are executable by at least one processor to cause the at least one processor to perform method 100.

According to one embodiment, the first account may be an enterprise financial account. In this embodiment or others, the second account may be a non-enterprise financial account that is unrelated to the first account. In other words, the second account may be hosted and managed by a system or platform completely separate from the enterprise server.

According to one embodiment, the enterprise server, prior to acquiring the client data, may be configured to receive, from the client device, a request to authenticate the client device. In response to this request, the enterprise server may acquire first authentication credentials of the client device and authenticate whether the client device is authorized to conduct transactions for the first account based on the first authentication credentials. Authentication credentials may take any form, such as username/password combination, two-factor authentication using a secondary device, an authenticator application executable on a device of the user, etc.

In an embodiment, the enterprise server may display, via the first GUI, a first indication that the second account has insufficient funds available to execute the first transaction in response to a determination that the amount of funds available in the second account is less than an amount of funds related to the first transaction. In other words, if there is less money available in the account than what is needed to conduct the first transaction, the user may be informed of this situation via the first GUI. Moreover, the first transaction may be held or cancelled until the situation is resolved.

In some embodiments, the enterprise server may be configured to acquire updated account data relating to the relevant account(s) from the related server device(s) (e.g., acquiring updated second account data from the third-party server device). There may be a trigger that causes the enterprise server to request updated account data, such as expiration of a timer, changes being made to account data, according to a schedule (e.g., every minute, every 20 minutes, every hour, every day, etc.), manual user input requesting an update, etc. After acquiring the updated account data, the enterprise server is configured to display, via the first GUI, updated second account data aggregated together with updated first account data.

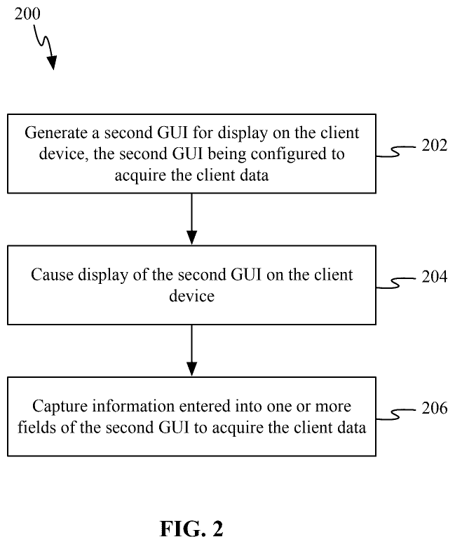

Now referring to FIG. 2, a flow chart of a computer-implemented method 200 for acquiring account data for managing multiple accounts in a single platform is shown according to one embodiment. Of course, more or less operations than those specifically described in FIG. 2 may be included in computer-implemented method 200, as would be understood by one of skill in the art upon reading the present descriptions.

Each of the operations of computer-implemented method 200 may be performed by any suitable component of the operating environment. For example, in various embodiments, computer-implemented method 200 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 200. Illustrative processors include, but are not limited to, a CPU, an ASIC, a FPGA, etc., combinations thereof, or any other suitable computing device known in the art.

In one embodiment, computer-implemented method 200 may be performed by an enterprise server that is configured to process electronic external and/or internal transactions and manage any number of accounts for one or more different platforms and/or electronic banking systems. Transactions may include any type of modification, exchange, movement, and/or trade, e.g., payments, deposits, transfers, copies, deletions, cancellations, etc. Although method 200 is described as being performed by an enterprise server, any suitable computing device may be used, alone or in combination with other electronic devices, to perform method 200 in various embodiments.

In operation 202, the enterprise server generates a second GUI for display on the client device. In this embodiment, the second GUI is configured to acquire the client data, and may be generated and/or provided to the client device prior to generating the first GUI for displaying the aggregated account data.

The second GUI may take any form and may appear to be integrated into an existing GUI being displayed, or appear as a pop-up or overlay window. Once the requesting information is entered into the second GUI, it may be removed from display or otherwise close. In one embodiment, the second GUI may be displayed in response to the user requesting that the second account be linked to the enterprise server and made accessible through an online portal hosted by the enterprise server. The second GUI may be displayed within a web browser in an embodiment. The second GUI may be displayed within an application executing on the client device in an embodiment.

In operation 204, the enterprise server may cause display of the second GUI on the client device. Causing display of the second GUI may include any of: transmitting the second GUI to the client device, hosting the second GUI as a cloud service for the client device, storing the second GUI to a storage location accessible to the client device, etc.

In operation 206, the enterprise server captures information entered into one or more fields of the second GUI to acquire the client data. The second GUI may be designed with text-based or multiselect fields configured for manipulation by a user, thereby allowing the user to enter specific, desired information into the fields for processing by the enterprise server. Some example fields include, but are not limited to: a password field, a username field, a unique code field for entry when accessing the account, a field to provide information to administer two-factor authentication, a field for entry of an account number associated with the second account, a field to enter a routing number associated with the second account, a field to enter a unique account signature, etc.

In one embodiment, the enterprise server may be configured to transmit the second GUI to the client device prior to acquiring the client data. In this way, the second GUI is available to the client device for display thereof, and as the user interacts with the second GUI, the information entered therein may be acquired by the enterprise server (e.g., transmitted, shared, or otherwise made available).

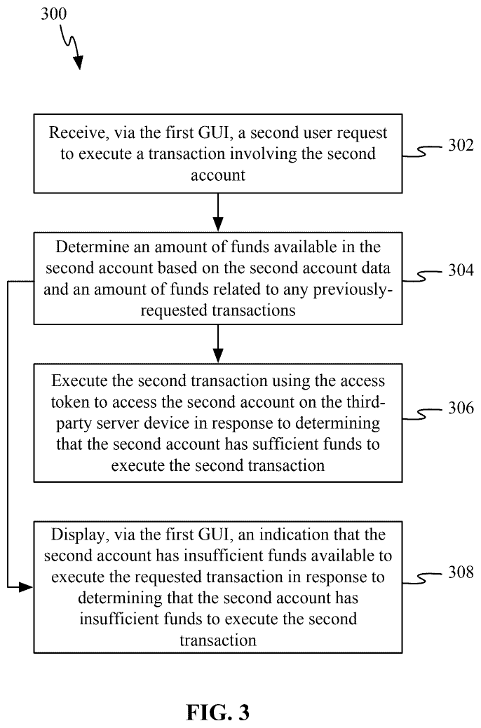

Now referring to FIG. 3, a flow chart of a computer-implemented method 300 for executing transactions for linked accounts is shown according to one embodiment. Of course, more or less operations than those specifically described in FIG. 3 may be included in computer-implemented method 300, as would be understood by one of skill in the art upon reading the present descriptions.

Each of the operations of computer-implemented method 300 may be performed by any suitable component of the operating environment. For example, in various embodiments, computer-implemented method 300 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 300. Illustrative processors include, but are not limited to, a CPU, an ASIC, a FPGA, etc., combinations thereof, or any other suitable computing device known in the art.

In one embodiment, computer-implemented method 300 may be performed by an enterprise server that is configured to process electronic external and/or internal transactions and manage any number of accounts for one or more different platforms and/or electronic banking systems. Transactions may include any type of modification, exchange, movement, and/or trade, e.g., payments, deposits, transfers, copies, deletions, cancellations, etc. Although method 300 is described as being performed by an enterprise server, any suitable computing device may be used, alone or in combination with other electronic devices, to perform method 300 in various embodiments.

In operation 302, the enterprise server receives, via the first GUI, a second user request to execute a transaction involving the second account. In one embodiment, the first GUI may be displayed to the client device via a web browser to allow the user access to an online portal for the enterprise server. In another embodiment, the first GUI may be displayed to the client device via an application executing on the client device that is designed for interacting with and displaying information specific to the enterprise server.

In operation 304, prior to executing the requested transaction using the access token, the enterprise server determines an amount of funds available in the second account based on the second account data (e.g., an amount of funds available in the second account prior to any transactions being performed) and an amount of funds related to any previously-requested transactions. This determination may include comparing the amount of funds available in the second account with the amount of funds related to the previous transaction(s). In this way, the enterprise server is able to ascertain whether sufficient funds are available in the second account prior to attempting any transaction against this account that might draw down the funds below zero (or some other desired threshold).

In some further approaches, the enterprise server may ascertain if future or pending transactions are posted against the second account that will affect the amount of funds available now or in the near term, prior to making the determination.

In operation 306, responsive to the enterprise server determining that the second account has sufficient funds to execute the requested transaction, the enterprise server executes the requested transaction using the access token to access the second account on the third-party server device.

In operation 308, responsive to the enterprise server determining that the second account has insufficient funds to execute the requested transaction, the enterprise server displays, via the first GUI, an indication that the second account has insufficient funds available to execute the requested transaction. In other words, if there is less money available in the second account than what is needed to conduct the requested transaction, the user is informed of this situation via the first GUI. Moreover, the requested transaction may be held until the situation is resolved or cancelled entirely. The first GUI may request confirmation from the user to alter the requested transaction along with and/or after displaying the indication, and hold on executing the requested transaction(s) until revisions are received by the enterprise server that causes the second account to have sufficient funds to execute the adjusted transaction.

In a further embodiment, the enterprise server may display, via the first GUI, a second indication showing an amount of funds that will remain in the second account after executing the requested transaction(s). This indication is based on the enterprise server comparing the amount of funds available in the second account with the amount of funds related to the requested transaction(s). In this way, the user may be apprised of the level of funds remaining after the transaction(s) is/are processed, in case any changes should be made based on the level of money in the account. The first GUI may request confirmation from the user to proceed with the requested transaction(s) along with and/or after displaying the second indication, and hold on executing the requested transaction(s) until confirmation is received by the enterprise server.

Moreover, in some approaches, the enterprise server may determine if the level of funds remaining will trigger some condition or fee (such as locking of the second account, payment of a monthly fee, overdraft fee, etc.), and inform the user of this information prior to executing the requested transaction(s). The first GUI may request confirmation from the user to proceed with the requested transaction(s) along with and/or after displaying this information, and hold on executing the requested transaction(s) until confirmation is received by the enterprise server.

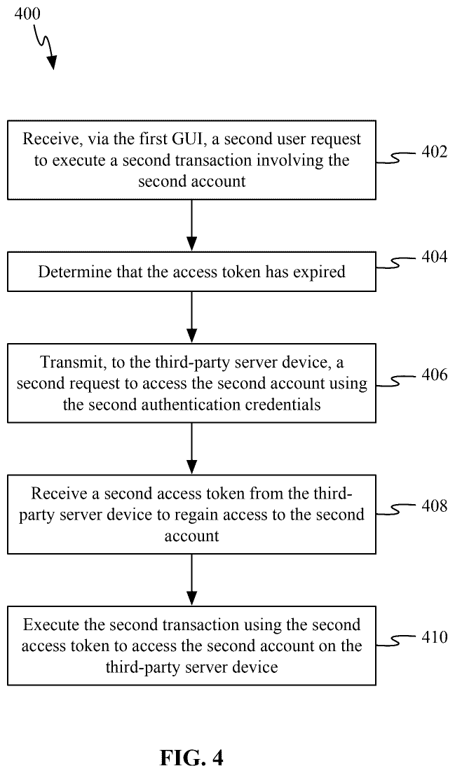

Now referring to FIG. 4, a flow chart of a computer-implemented method 400 for executing transactions for linked accounts is shown according to one embodiment. Of course, more or less operations than those specifically described in FIG. 4 may be included in computer-implemented method 400, as would be understood by one of skill in the art upon reading the present descriptions.

Each of the operations of computer-implemented method 400 may be performed by any suitable component of the operating environment. For example, in various embodiments, computer-implemented method 400 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 400. Illustrative processors include, but are not limited to, a CPU, an ASIC, a FPGA, etc., combinations thereof, or any other suitable computing device known in the art.

In one embodiment, computer-implemented method 400 may be performed by an enterprise server that is configured to process electronic external and/or internal transactions and manage any number of accounts for one or more different platforms and/or electronic banking systems. Transactions may include any type of modification, exchange, movement, and/or trade, e.g., payments, deposits, transfers, copies, deletions, cancellations, etc. Although method 400 is described as being performed by an enterprise server, any suitable computing device may be used, alone or in combination with other electronic devices, to perform method 400 in various embodiments.

In operation 402, the enterprise server receives, via the first GUI, a second user request to execute a second transaction involving the second account. In one embodiment, the first GUI may be displayed to the client device via a web browser to allow the user access to an online portal for the enterprise server. In another embodiment, the first GUI may be displayed to the client device via an application executing on the client device that is designed for interacting with and displaying information specific to the enterprise server.

In operation 404, the enterprise server determines that the access token has expired (if the access token is still valid, then no further action will be taken in regard to the access token). The enterprise server may determine that the access token has expired in response to attempting to execute the second transaction through the third-party server device in one approach.

In operation 406, in response to the access token having expired, the enterprise server transmits, to the third-party server device, a second request to access the second account using the second authentication credentials. This second request may be provided or transmitted in a similar manner to that in which the first request was provided or transmitted to the third-party server device in one approach. In another approach, a communication channel may have been created as a result of the first request to access the second account, and this communication channel may be used to re-acquire a valid access token from the third-party server device.

In operation 408, in response to this second request, the enterprise server receives a second access token from the third-party server device to regain access to the second account. The second access token may be the same as the first access token in some approaches (e.g., changes are made at the third-party server device that would now allow the first access token to work again).

In operation 410, the enterprise server will again have access to the second account through the third-party server device, and executes the second transaction using the second access token to access the second account on the third-party server device.

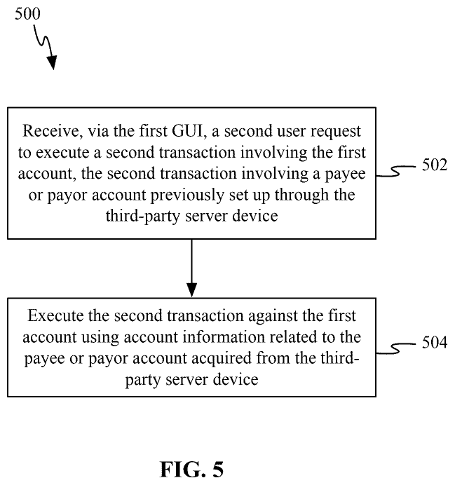

Now referring to FIG. 5, a flow chart of a computer-implemented method 500 for executing transactions for linked accounts is shown according to one embodiment. Of course, more or less operations than those specifically described in FIG. 5 may be included in computer-implemented method 500, as would be understood by one of skill in the art upon reading the present descriptions.

Each of the operations of computer-implemented method 500 may be performed by any suitable component of the operating environment. For example, in various embodiments, computer-implemented method 500 may be partially or entirely performed by a cloud server, a portable computer, a handheld or wearable computer, a mobile device, one or more hardware processors of a computing device, an application operating on a computing device, a server device, a processing circuit having one or more processors therein, or some other device having one or more processors therein. The processing circuit, e.g., processor(s), chip(s), and/or module(s) implemented in hardware and/or software, and preferably having at least one hardware component, may be utilized in any device to perform one or more operations of computer-implemented method 500. Illustrative processors include, but are not limited to, a CPU, an ASIC, a FPGA, etc., combinations thereof, or any other suitable computing device known in the art.

In one embodiment, computer-implemented method 500 may be performed by an enterprise server that is configured to process electronic external and/or internal transactions and manage any number of accounts for one or more different platforms and/or electronic banking systems. Transactions may include any type of modification, exchange, movement, and/or trade, e.g., payments, deposits, transfers, copies, deletions, cancellations, etc. Although method 500 is described as being performed by an enterprise server, any suitable computing device may be used, alone or in combination with other electronic devices, to perform method 500 in various embodiments.

In operation 502, the enterprise server receives, via the first GUI, a second user request to execute a second transaction involving the first account. In this embodiment, the second transaction may involve a payee or payor account previously set up through the third-party server device (e.g., set up for use with the second account). Typically, the enterprise server would not have access to these payee/payor accounts; however, in this embodiment, the second account data that was previously acquired by the enterprise server includes one or more payee/payor accounts that are set up for use with the second account. Therefore, in acquiring the second account data, the enterprise server now has access to this information, thereby allowing it to conduct transactions through these entities using the first account (as would be possible through the second account via the third-party server device).

In operation 504, responsive to receiving the second user request to execute the second transaction, the enterprise server executes the second transaction using, involving, and/or against the first account using account information related to the payee or payor account acquired from the third-party server device. In this way, once a user has entered information for payee/payor accounts and set up the functionality to make transactions with these various payee/payor accounts across multiple different platforms, all of this functionality will be made available through the first GUI provided by the enterprise server for transactions across any of the various accounts linked through the enterprise server.

With reference to FIG. 6, a management platform is shown in accordance with one embodiment. Although other types of GUIs and platforms may be supported by the various embodiments described herein, a wealth management platform 600 is described with respect to FIG. 6. Various management platforms in other embodiments may have different functionality, purpose, organization, or layout than that shown in FIG. 6.

Also, various images, logos, icons, graphics, etc., may be included in the wealth management platform 600 in various approaches. Moreover, the wealth management platform 600 may de designed, configured, and implemented in different ways than those shown and described in FIG. 6, which shows an exemplary GUI capable of displaying aggregated account data.

As shown, the wealth management platform 600 includes three user interface (UI) elements representing different accounts linked to the enterprise server: an account with Alpha Bank 602, an account with Trinity Credit Union 622, and an account with Better investments 624.

In the Alpha Bank UI 602, the name of the account 604 is displayed, along with the account number 606. The UI 602 also includes various example UI elements that are selectable/functional to perform various related activities: a “View Transactions” UI element 610 for viewing past and future transactions that affect the accounts, a “Remove Account” UI element 612 for removing the related account from the wealth management platform 600, a “Transfer” UI element 614 for setting up a transfer between accounts, a “Setup New Payee” UI element 616 for setting up a new payee account, a “New Payment” UI element 618 for entering a new payment into or out of one of the accounts, and a “Other Actions” UI element 620, a generic link for accessing additional actions. Any functions, services, processes, actions, and abilities not shown in the Alpha Bank UI 602 may be stored under the “Other Actions” UI element 620, which upon selection by the user may cause a pop-up, overlay, or new window to be displayed that includes all other possible selections for the user, including those specifically described herein and/or others that would be known to one of skill in the art. As shown, the user has $12,300 available in the Alpha Bank account having account number 10045678.

For the Trinity Credit Union UI 622, all the same UI elements having the same functions/actions are available for transacting with this account. As shown, the user has $5,465.23 available in the Trinity Credit Union account having account number 267312-435.

For the Better Investments UI 624, many of the same UI elements having the same functions/actions are available for transacting with this account, with some additional actions specific to this type of account having different UI elements. These additional UI elements include a “Rebalance” UI element 626 for rebalancing the investments held in the account and a “Tax Documents” UI element 628 for accessing/viewing tax documents. As shown, the user has $215,434.78 available in the Better Investments account having account number 90096231101.

Many other actions may be available for interaction with by the user via the wealth management platform 600 other than those shown in FIG. 6. These additional actions may be specific to the account types shown, or used generally for several account types, in various embodiments.

The wealth management platform 600 also includes a “Link Account” UI element 630 and a “Manage Features” UI element 632. The “Link Account” UI element 630 is configured to link another account to the enterprise server, for integration and aggregation within the wealth management platform 600. The “Manage Features” UI element 632 is configured to manage the features of the wealth management platform 600, such as which information and UI elements to show for each account type and/or account type, how many accounts to display on a single page, an ordering of UI elements, etc.

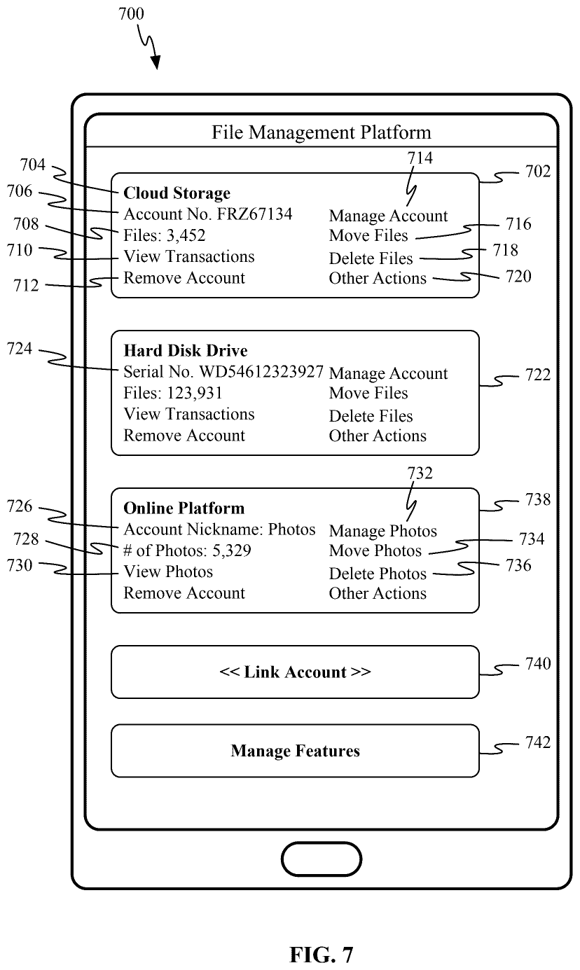

FIG. 7 shows a management platform in accordance with one embodiment. Although other types of GUIs and platforms may be supported by the various embodiments described herein, a file management platform 700 is described with respect to FIG. 7. Various management platforms in other embodiments may have different functionality, purpose, organization, or layout than that shown in FIG. 7.

Also, various images, logos, icons, graphics, etc., may be included in the file management platform 700 in various approaches. Moreover, the file management platform 700 may de designed, configured, and implemented in different ways than those shown and described in FIG. 7, which shows an exemplary GUI capable of displaying aggregated account data.

As shown, the file management platform 700 includes three UI elements representing different accounts linked to the enterprise server: Cloud Storage 702, Hard Disk Drive 722, and an Online Platform 738.

In the Cloud Storage UI 702, the name of the account 704 is displayed, along with the account number 706. The Cloud Storage UI 702 also includes various example UI elements that are selectable/functional to perform various related activities: a “Files” UI element 708 showing the number of and allowing access to the files that are associated with the Cloud Storage account, a “View Transactions” UI element 710 for viewing past and future transactions that affect the account, a “Remove Account” UI element 712 for removing the related account from the file management platform 700, a “Manage” UI element 714 for managing the account, a “Move Files” UI element 716 for moving files within or out of the account, a “Delete Files” UI element 718 for deleting one or more files from the account, and a “Other Actions” UI element 720, a generic link for accessing additional actions. Any functions, services, processes, actions, and abilities not shown in the Cloud Storage UI 702 may be stored under the “Other Actions” UI element 720, which upon selection by the user may cause a pop-up, overlay, or new window to be displayed that includes all other possible selections for the user, including those specifically described herein and/or others that would be known to one of skill in the art. As shown, the user has 3,452 files stored in the Cloud Storage account having account number FRZ67134.

For the Hard Disk Drive UI 722, all the same UI elements having the same functions/actions are available for transacting with this account. As shown, the user has 123,931 files stored to the hard disk drive, which has a serial number of WD54612323927 shown by the “Serial No.” UI element 724.

For the Online Platform UI 738, some different UI elements specific to this type of account are shown. These additional UI elements include an “Account Nickname” UI element 726 showing the nickname associated with this account, a “#of Photos” UI element 728 showing the number of photos available through this account, a “View Photos” UI element 730 for accessing/viewing the photos stored to this account, a “Manage Photos” UI element 732 for managing the various photos stored to this account, a “Move Photos” UI element 734 for moving one or more photos within or out of this account, and a “Delete Photos” UI element 736 for deleting one or more photos from this account. As shown, the user has 5,329 photos stored to this account nicknamed “Photos.”

Many other actions may be available for interaction with by the user via the file management platform 700 other than those shown in FIG. 7. These additional actions may be specific to the account types shown, or used generally for several account types, in various embodiments.

The file management platform 700 also includes a “Link Account” UI element 740 and a “Manage Features” UI element 742. The “Link Account” UI element 740 is configured to link another account to the enterprise server, for integration and aggregation within the file management platform 700. The “Manage Features” UI element 742 is configured to manage the features of the file management platform 700, such as which information and UI elements to show for each account type and/or account type, how many accounts to display on a single page, an ordering of UI elements, etc.

According to one embodiment, the techniques described herein are implemented by one or more special-purpose computing devices (i.e., computing devices specially configured to perform certain functionality). The special-purpose computing devices may be hard-wired to perform the techniques, or may include digital electronic devices such as one or more ASICs, FPGAs, or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

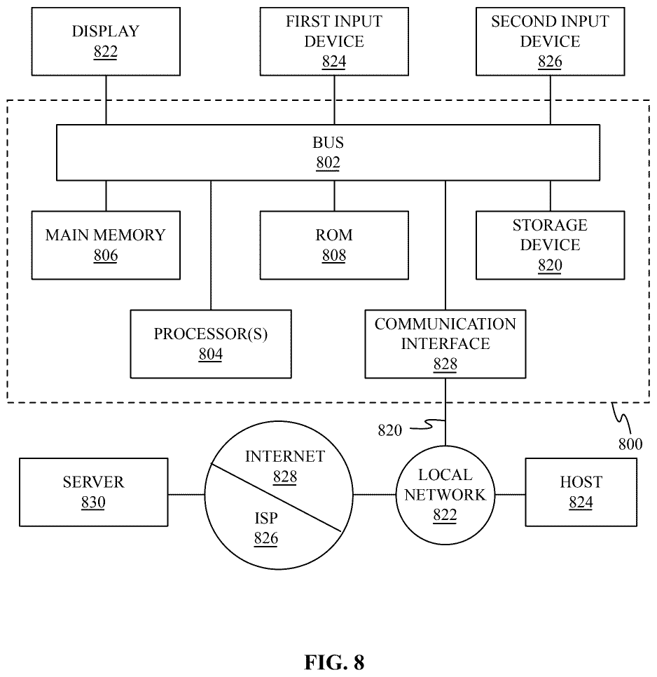

For example, FIG. 8 is a block diagram that illustrates a computer system 800 upon which an embodiment of the invention may be implemented. Computer system 800 may be any type of system known in the art, such as a mobile device (smartphone, tablet, laptop, etc.), desktop computer, server, appliance, etc. As an option, computer system 800 may be implemented in conjunction with features from any other embodiments listed herein, such as those described with reference to any of FIGS. 1-7. Referring again to FIG. 8, computer system 800 includes a bus 802 or other communication mechanism for communicating information, and one or more hardware processors 804 coupled with bus 802 for processing information. The hardware processor(s) 804 may be of any type, for example, a general-purpose microprocessor, a central processing unit (CPU), a graphics processing unit (GPU), a microcontroller, etc.

Computer system 800 also includes a main memory 806 coupled to bus 802 for storing information and instructions to be executed by the processor(s) 804. Main memory 806 stores an operating system (OS). The OS includes instructions for handling basic system services and for performing hardware dependent tasks. Main memory 806 may additionally include instructions that cause computer system 800 to perform processes of the various embodiments described herein. In some embodiments, these instructions may be a subset of the OS or may be part of the instructions for an application.

In some embodiments, main memory 806 also may be used for storing temporary variables or other intermediate information during execution of instructions to be executed by processor(s) 804. Such instructions, when stored in non-transitory storage media accessible to processor(s) 804, render computer system 800 into a special-purpose machine that is customized to perform the operations specified in the instructions. In some embodiments, main memory 806 may include volatile memory (e.g., high-speed random access memory), non-volatile memory (e.g., flash memory), a combination of volatile and non-volatile memory, and/or any other type of memory.

Main memory 806 may also include instructions for controlling other aspects of computer system 800, such as communication instructions to facilitate communicating with one or more additional devices (e.g., for peer-to-peer data sharing, to connect to a server through the Internet for cloud-based data sharing, etc.); graphical user interface (GUI) instructions to facilitate GUI processing; image processing instructions to facilitate image-related processing and functions; input processing instructions to facilitate input-related processes and functions (e.g., mouse cursor, touch input, etc.); audio processing instructions to facilitate audio-related processes and functions; and camera instructions to facilitate camera-related processes and functions, etc. The instructions described above are merely exemplary and main memory 806 may include additional and/or other instructions in some embodiments. The above-identified instructions need not be implemented as separate software programs or modules. Various functions of computer system 800 may be implemented in hardware and/or in software, including in one or more signal processing and/or application specific integrated circuits.

Computer system 800 may further include a read only memory (ROM) 808 or other static storage device coupled to bus 802 for storing static information and instructions for processor(s) 804. A storage device 810, such as a magnetic disk or solid-state disk, is provided and coupled to bus 802 for storing information and instructions.

Computer system 800 may be coupled via bus 802 to a display 812, such as a liquid crystal display (LCD), light emitting diode (LED) display, touchscreen display, electronic ink display, cathode ray tube (CRT) monitor, or any other kind of device for displaying information to a user. A first input device 814, such as a keyboard or virtual keyboard that provides for selection of alphanumeric and/or other characters, may be coupled to bus 802 for communicating information and command selections to processor 804.

Alternatively, or in addition, computer system 800 may receive user input via a second input device 816, such as a mouse, a trackball, a trackpad, a touchscreen, a slider, and/or cursor direction keys. The second input device 816 may be configured for providing direction information, communicating command selections to processor 804, controlling cursor movement on display 812, etc. The second input device 816 may have at least two degrees of freedom in two axes, a first axis (e.g., x) and a second axis (e.g., y), that allows the second input device 816 to specify positions in a plane. The display 812 may be configured to receive user input via one or more pressure-sensitive sensors, multi-touch sensors, and/or gesture sensors. Alternatively, or in addition, computer system 800 may receive user input via a microphone, video camera, and/or some other kind of user input device (not shown).

Computer system 800 may implement the techniques described herein using customized hard-wired logic, one or more ASICs or FPGAs, firmware, and/or program logic which in combination with the computer system causes, configures, or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein in various embodiments. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, solid-state or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a programmable read-only memory (PROM), and erasable PROM (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio wave and infrared data communications.

Various forms of media may be involved in carrying one or more sequences of one or more instructions to processor(s) 804 for execution. For example, the instructions may initially be carried on a magnetic disk or solid-state drive of a remote computer. The remote computer can load the instructions into its dynamic memory and send the instructions over a network, via a network interface controller (NIC), such as an Ethernet controller or Wi-Fi controller. A NIC local to computer system 800 can receive the data from the network and place the data on bus 802. Bus 802 carries the data to main memory 806, from which processor(s) 804 retrieves and executes the instructions. The instructions received by main memory 806 may optionally be stored on storage device 810 either before or after execution by processor(s) 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a LAN card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor(s) 804 as it is received, and/or stored in storage device 810, or other non-volatile storage for later execution.

One or more peripheral devices may be coupled to computer system 800, such as various sensors and subsystems. Some example peripheral devices include, but are not limited to, a camera subsystem, a wired communication subsystem, a wireless communication. subsystem, an audio subsystem, an I/O subsystem, etc. The peripheral devices may communicate with the processor(s) 804 directly through bus 802 or via a peripherals interface. In one example, an orientation sensor (e.g., a gyroscope) and an acceleration sensor (e.g., an accelerometer) may be coupled to the peripherals interface to facilitate orientation and acceleration functions for computer system 800.

In several examples, computer system 800 may include a camera subsystem that is coupled to one or more optical sensors (e.g., a charged coupled device (CCD) optical sensor, a complementary metal-oxide-semiconductor (CMOS) optical sensor, etc.). The optical sensors may facilitate camera functions, such as capturing image and/or video data. A wired communication subsystem and/or wireless communication subsystem may also be included to facilitate communication functions via one or more connections.

In some examples, computer system 800 may include a wireless communication subsystem having one or more radio frequency receivers and transmitters, optical receivers, and transmitters. These receivers and transmitters may be implemented to operate over one or more communication networks, such as a GSM network, a Wi-Fi network, a Bluetooth network, etc. An audio subsystem may be included in computer system 800, with the audio subsystem being coupled to a speaker or an output audio (e.g., to output music, voice navigation instructions, signals, etc.). Additionally or alternatively, the audio subsystem may be coupled to a microphone to facilitate audio input, such as voice-enabled functions in one example.

In an example, computer system 800 may include an I/O subsystem that is configured for managing transfer of data between input/output peripheral devices, such as a display, a touch screen, etc., and bus 802, e.g., via a peripherals interface. The I/O subsystem may include a touch-screen controller and/or other input controllers to facilitate the transfer between input/output peripheral devices and bus 802 of computer system 800. In this example, the touch-screen controller may be coupled to a touch screen for detecting contact and movement on the touch screen using any of multiple touch sensitivity technologies.

While the components illustrated in FIG. 8 are shown separately, one of ordinary skill in the art will recognize that two or more components may be integrated together, such as into one or more integrated circuits. In addition, two or more components may be coupled together by one or more communication buses or signal lines. Also, while many of the functions are described as being performed by a particular component, one of ordinary skill in the art will recognize that the functions described with respect to FIG. 8 may be split into multiple integrated circuits.

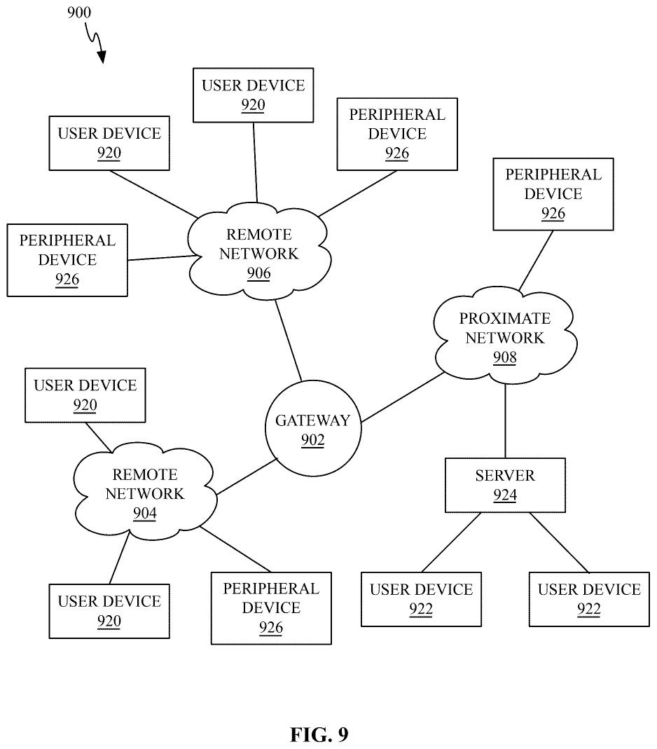

FIG. 9 illustrates a network architecture 900, in accordance with one or more embodiments. The computer system 800 of FIG. 8 may utilize any of the components described in network architecture 900 of FIG. 9, in various approaches. As an option, the present architecture 900 may be implemented in conjunction with features from any other embodiments listed herein, such as those described with reference to any of FIGS. 1-7. Of course, however, network architecture 900 of FIG. 9 and others presented herein may be used in various applications and/or in permutations which may or may not be specifically described in the illustrative embodiments listed herein. Further, network architecture 900 presented herein may be used in any desired environment.

One or more remote and/or proximate networks may be provided in network architecture 900. As shown in FIG. 9, network architecture 900 includes a first remote network 904 and a second remote network 906. A gateway 902 may be coupled between the remote networks 904, 906 and a proximate network 908. In the context of the present network architecture 900, the networks 904, 906, 908 may each take any form including, but not limited to, a LAN, a WAN such as the Internet, a storage area network (SAN), a public switched telephone network (PSTN), an internal telephone network, etc. Additional networks may also be connected via the gateway 902 or some other connection device known in the art. These networks may be of a different type than the networks 904, 906, 908. For example, a network may be devoted to the Internet of Things (IOT) and may provide infrastructure and protocols for communication between all devices in the IOT, and between any devices in the IOT and one or more of the other networks. In another example, a network may be devoted to Industrial control, and may provide infrastructure and protocols for communication within and/or between facilities anywhere in the world, including automated devices, manufacturing lines, assembly lines, processing control software, etc.

In use, the gateway 902 serves as an entrance point from the remote networks 904, 906 to the proximate network 908. As such, the gateway 902 may function as a router, configured to direct a given packet of data that arrives at the gateway 902, and a switch, which furnishes the actual path in and out of the gateway 902 for a given packet. In some embodiments, router functionality and switching functionality may be embodied in one or more different or additional devices.

Further included in the network architecture 900 is at least one server 914 coupled to the proximate network 908, and which is accessible from the remote networks 904, 906 via the gateway 902. It should be noted that the server(s) 914 may include any type of computing device/groupware, and may be of any type of server, e.g., a data server, financial server, cloud server, etc. A plurality of user devices 912 may be coupled to any server 914. User devices 912 may include any device known by one of skill in the relevant art, such as a desktop computer, a laptop computer, a hand-held computer, a smartphone, a terminal, a port, a printer, an automated teller machine (ATM), a debit or credit card reader device, a point of sale (POS) device, or some other type or form of processing logic, etc. It should be noted that one or more user devices 910 may also be directly coupled to any of the remote networks 904, 906, in various embodiments.

A peripheral 916 or series of peripherals, e.g., scanners, printers, networked storage units, hard disk drives, wireless routers, ATM, debit or credit card reader device, POS device, etc., may be coupled to one or more of the networks 904, 906, 908. It should be noted that databases, servers, mainframes, and/or additional components may be utilized with and/or integrated into any type of network element coupled to the networks 904, 906, 908. In the context of the present descriptions, a network element may refer to any component of a network, system, device, and/or any device useable in a network.

According to some approaches, methods and systems described herein may be implemented with and/or utilized on virtual systems and/or systems which emulate one or more other systems, such as a UNIX® system which emulates a macOS® environment, a UNIX® system which virtually hosts a Microsoft Windows® environment, a Microsoft Windows® system which emulates a macOS® environment, etc. This virtualization and/or emulation may be enhanced using virtualization software, such as VMware ESX®, Microsoft Hyper-V®, Intel Simics®, etc., in some embodiments.

In more approaches, one or more of the networks 904, 906, 908 may represent a cluster of systems commonly referred to as a “cloud.” In a cloud or “cloud computing,” shared resources, such as processing power, peripherals, software, data processing, servers, storage, etc., are provided to any system that has access to the cloud and permission to access the specific resource, preferably in an on-demand relationship. This allows for access and distribution of services across many computing systems. Cloud computing typically involves an Internet or other high-speed connection (e.g., 5G, fiber optic, etc.) between the systems operating in the cloud, but other techniques of connecting the systems may also be used, as would be understood by one of skill in the relevant art.

Variations of the embodiments described herein are also possible, and the explicit description thereof in these descriptions is not required to provide one of skill in the relevant art with the ability to conceive of such variations when reading the present descriptions.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computer-implemented method for managing multiple accounts,
the computer-implemented method comprising:
acquiring, by an enterprise server from a client device authenticated to conduct transactions relating to a first account, client data to link a second account to the first account managed by the enterprise server, the client data comprising:
a) a consent for access rights to the second account managed by a third-party server device; and
b) second authentication credentials for accessing the second account;
storing, by the enterprise server, the client data to a first storage location accessible to the enterprise server;
transmitting, by the enterprise server to the third-party server device, a request to access the second account using the second authentication credentials;
receiving, by the enterprise server, an access token from the third-party server device to gain access to the second account;
acquiring, by the enterprise server, second account data relating to the second account from the third-party server device;
generating, by the enterprise server, a first graphical user interface (GUI) for display on the client device, the first GUI aggregating together the second account data and first account data relating to the first account managed by the enterprise server;
receiving, by the enterprise server via the first GUI, a user request to execute a first transaction involving the second account; and
executing, by the enterprise server, the first transaction using the access token to access the second account on the third-party server device.

2. The computer-implemented method as recited in claim 1, wherein the first account is an enterprise financial account, and wherein the second account is an unrelated non-enterprise financial account.

3. The computer-implemented method as recited in claim 1, further comprising generating, by the enterprise server, a second GUI for display on the client device, the second GUI being configured to acquire the client data.

4. The computer-implemented method as recited in claim 3, further comprising:
causing, by the enterprise server, display of the second GUI on the client device; and
capturing, by the enterprise server, information entered into one or more fields of the second GUI to acquire the client data.

5. The computer-implemented method as recited in claim 3, further comprising transmitting, by the enterprise server, the second GUI to the client device prior to acquiring the client data.

6. The computer-implemented method as recited in claim 1, wherein the first transaction is selected from a group comprising: a) an inter-account transfer or payment from the first account to the second account, b) an inter-account transfer or payment from the second account to the first account, c) and a transfer or payment from the second account to a third account unrelated to the first account or the second account.

7. The computer-implemented method as recited in claim 1, further comprising, prior to acquiring the client data:
receiving, from the client device at the enterprise server, a request to authenticate the client device;
acquiring, by the enterprise server, first authentication credentials of the client device; and
authenticating, by the enterprise server, that the client device is authorized to conduct transactions for the first account based on the first authentication credentials.

8. The computer-implemented method as recited in claim 1, further comprising, prior to executing the first transaction using the access token:
determining, by the enterprise server, an amount of funds available in the second account based on the second account data; and
comparing, by the enterprise server, the amount of funds available in the second account with an amount of funds related to the first transaction.

9. The computer-implemented method as recited in claim 8, further comprising displaying, by the enterprise server via the first GUI, a first indication that the second account has insufficient funds available to execute the first transaction based on determining that the amount of funds available in the second account is less than the amount of funds related to the first transaction.

10. The computer-implemented method as recited in claim 8, further comprising displaying, by the enterprise server via the first GUI, a second indication of an amount of funds that will remain in the second account after executing the first transaction based on comparing the amount of funds available in the second account with the amount of funds related to the first transaction.

11. The computer-implemented method as recited in claim 1, further comprising:
receiving, by the enterprise server via the first GUI, a second user request to execute a second transaction involving the second account;
determining, by the enterprise server, an amount of funds available in the second account based on the second account data and an amount of funds related to the first transaction; and
executing, by the enterprise server, the second transaction using the access token to access the second account on the third-party server device in response to determining that the second account has sufficient funds to execute the second transaction.

12. The computer-implemented method as recited in claim 1, further comprising:
receiving, by the enterprise server via the first GUI, a second user request to execute a second transaction involving the second account;
determining, by the enterprise server, that the access token has expired;
transmitting, by the enterprise server to the third-party server device, a second request to access the second account using the second authentication credentials;
receiving, by the enterprise server, a second access token from the third-party server device to regain access to the second account; and
executing, by the enterprise server, the second transaction using the second access token to access the second account on the third-party server device.

13. The computer-implemented method as recited in claim 1, further comprising:
receiving, by the enterprise server via the first GUI, a second user request to execute a second transaction involving the first account, wherein the second transaction involves a payee or payor account previously set up through the third-party server device; and
executing, by the enterprise server, the second transaction against the first account using account information related to the payee or payor account acquired from the third-party server device.

14. The computer-implemented method as recited in claim 1, further comprising:
acquiring, by the enterprise server, updated second account data relating to the second account from the third-party server device in response to expiration of a timer; and
displaying, by the enterprise server via the first GUI, the updated second account data aggregated together with updated first account data.

15. The computer-implemented method as recited in claim 1, wherein the second account data comprises:
a) an amount of funds available in the second account;
b) previous transactions related to the second account over a predetermined amount of time; and
c) one or more types of transactions that are available for execution with the second account.

16. The computer-implemented method as recited in claim 1, wherein the second authentication credentials for accessing the second account comprise a username and password combination for accessing the second account through an online portal managed by the third-party server device.

17. The computer-implemented method as recited in claim 1, wherein the second authentication credentials for accessing the second account comprise:
a) an account number associated with the second account; and
b) a routing number associated with the second account.

18. The computer-implemented method as recited in claim 1, wherein the first transaction involves a payee account or a payor account previously set up through the third-party server device, and wherein the first transaction is executed using account information related to the payee or payor account acquired from the third-party server device.

19. A system for managing multiple accounts, the system comprising:
at least one processor; and
a non-transitory computer-readable medium having instructions embodied therewith that, when executed by the at least one processor, cause the at least one processor to perform operations comprising:
acquiring, by an enterprise server from a client device, client data to link a second account to a first account managed by the enterprise server, wherein the client device is authenticated to conduct transactions relating to the first account, and wherein the client data comprises:
a) a consent for access rights to the second account managed by a third-party server device; and
b) second authentication credentials for accessing the second account;
storing, by the enterprise server, the client data to a first storage location accessible to the enterprise server;
transmitting, by the enterprise server to the third-party server device, a request to access the second account using the second authentication credentials;
receiving, by the enterprise server, an access token from the third-party server device to gain access to the second account;
acquiring, by the enterprise server, second account data relating to the second account from the third-party server device;
generating, by the enterprise server, a first graphical user interface (GUI) for display on the client device, the first GUI aggregating together the second account data and first account data relating to the first account managed by the enterprise server;
receiving, by the enterprise server via the first GUI, a user request to execute a first transaction involving the second account; and
executing, by the enterprise server, the first transaction using the access token to access the second account on the third-party server device.

20. A computer program product for managing multiple accounts, the computer program product comprising a non-transitory computer-readable storage medium having program instructions embodied therewith that, when executed by the at least one processor, cause the at least one processor to perform operations comprising:
acquiring, by an enterprise server from a client device, client data to link a second account to a first account managed by the enterprise server, wherein the client device is authenticated to conduct transactions relating to the first account, and wherein the client data comprises:
a) a consent for access rights to the second account managed by a third-party server device; and
b) second authentication credentials for accessing the second account;
storing, by the enterprise server, the client data to a first storage location accessible to the enterprise server;
transmitting, by the enterprise server to the third-party server device, a request to access the second account using the second authentication credentials;
receiving, by the enterprise server, an access token from the third-party server device to gain access to the second account;
acquiring, by the enterprise server, second account data relating to the second account from the third-party server device;
generating, by the enterprise server, a first graphical user interface (GUI) for display on the client device, the first GUI aggregating together the second account data and first account data relating to the first account managed by the enterprise server;
receiving, by the enterprise server via the first GUI, a user request to execute a first transaction involving the second account; and
executing, by the enterprise server, the first transaction using the access token to access the second account on the third-party server device.
